(19) United States
(12) Patent Application Publication
(10) Pub. No.: US 2020/0317468 A1
(43) Pub. Date: Oct. 8, 2020

(54) ELEVATOR SYSTEM HAVING SHAFT-CHANGING UNITS AND METHOD FOR OPERATING AN ELEVATOR SYSTEM HAVING SHAFT-CHANGING UNITS

(71) Applicant: thyssenkrupp Elevator Innovation and Operations AG, Essen (DE)

(72) Inventors: Stefan KNEISLER, Adelberg (DE); Daniel BAUER, Durlangen (DE)

(73) Assignee: thyssenkrupp Elevator Innovation and Operations AG, Essen (DE)

(21) Appl. No.: 16/755,026

(22) PCT Filed: Oct. 18, 2018
(86) PCT No.: PCT/EP2018/078482

§ 371 Date: Apr. 9, 2020

(30) Foreign Application Priority Data
Oct. 25, 2017 (DE) 10 2017 219 146.5

(51) Int. Cl. B66B 1/28; B66B 9/00; B66B 1/30; B66B 1/32

(52) U.S. Cl. CPC B66B 1/28; B66B 9/003; B66B 1/32; B66B 1/30; B66B 1/285

(57) ABSTRACT

A method can be utilized to operate an elevator installation comprising at least two elevator shafts, an elevator cabin, a control system, and a shaft changeover unit. With regard to the elevator cabin, the shaft changeover unit can adopt an enabled state in which entry into the shaft changeover unit is permitted and a disabled state in which entry into the shaft changeover unit is blocked. A travel route from a start position in the shaft system to a destination position in the shaft system via the shaft changeover unit is determined for the elevator cabin, whereby the elevator cabin is moved proceeding from the start position, and the control system controls a travel parameter of the elevator cabin such that the elevator cabin, proceeding from the start position, reaches the shaft changeover unit when the shaft changeover unit is in the enabled state for the elevator cabin.

The invention relates to a method for operating an elevator installation comprising a shaft system with at least two elevator shafts, comprising at least one elevator cabin which is movable in the shaft system, comprising a control system, and comprising at least one shaft changeover unit by means of which an elevator cabin of the elevator installation can change over from a first elevator shaft of the shaft system into a second elevator shaft of the shaft system. With regard to an elevator cabin of the elevator installation, the at least one shaft changeover unit can adopt an enabled state, in which said elevator cabin is permitted to enter said shaft changeover unit, and a disabled state, in which said elevator cabin is blocked from entering said shaft changeover unit. Here, the method comprises, as a method step, that a first travel route from a first start position in the shaft system to a first destination position in the shaft system utilizing a first shaft changeover unit of the elevator installation is determined for a first elevator cabin of the elevator installation.

The invention furthermore relates to an elevator installation having a shaft system which comprises at least two elevator shafts, having at least one elevator cabin which is movable in the shaft system, having a control system, and having at least one shaft changeover unit by means of which an elevator cabin of the elevator installation can change over from a first elevator shaft of the shaft system into a second elevator shaft of the shaft system. Here, with regard to an elevator cabin of the elevator installation, the at least one shaft changeover unit can adopt an enabled state and a disabled state, wherein, in the enabled state, said elevator cabin is permitted to enter said shaft changeover unit, and wherein, in the disabled state, said elevator cabin is blocked from entering said shaft changeover unit.

Elevator installations which have multiple elevator shafts and multiple elevator cabins are well known in the prior art. In particular, so-called multi-cabin elevator installations are known in which a multiplicity of elevator cars can be moved individually, that is to say substantially independently of one another, for example utilizing linear motor drives. Here, the elevator cars can be relocated from one elevator shaft into a further elevator shaft utilizing shaft changeover units, in particular by means of a so-called exchanger as a shaft changeover unit. Furthermore, utilizing a shaft changeover unit, it is also possible to realize a change in direction of travel, for example by virtue of the direction of travel of an elevator car changing over from the vertical into the horizontal or vice versa. Here, the shaft changeover units in effect produce the connection between different elevator shafts. In order to be able to change over from one elevator shaft into another elevator shaft, the elevator cabins must in this case firstly enter the shaft changeover unit. For this purpose, for the elevator cabin that is to enter the shaft changeover unit, the shaft changeover unit must firstly adopt the enabled state for said elevator cabin. This means that an interruption in the travel of said elevator cabin is sometimes necessary until the shaft changeover unit has adopted the enabled state for said elevator cabin. Owing to the waiting times caused as a result, the transport capacity of such an elevator installation is restricted. As has been found, such waiting of the elevator cabin is furthermore perceived negatively by elevator users present in said elevator cabin, in particular because, within the elevator cabin, it is not apparent why the elevator cabin is waiting. Rather, the elevator users are given the impression that the time of arrival at the destination is being unnecessarily delayed. Some users could even erroneously assume that a fault has occurred and place an emergency call or notify service personnel.

Against this background, it is an object of the present invention to improve a method for operating such an elevator installation, in particular in such a way that elevator users have a positive user experience and the transport capacity of the elevator installation is advantageously increased.

To achieve said object, a method for operating an elevator installation, and an elevator installation, according to the independent claims are proposed. Further advantageous embodiments of the invention are described in the dependent claims and in the description and are illustrated in the figures.

The proposed solution provides a method for operating an elevator installation comprising a shaft system with at least two elevator shafts, comprising at least one elevator cabin which is movable in the shaft system, comprising a control system, and comprising at least one shaft changeover unit by means of which an elevator cabin of the elevator installation can change over from a first elevator shaft of the shaft system into a second elevator shaft of the shaft system. Here, with regard to an elevator cabin of the elevator installation, the at least one shaft changeover unit can adopt an enabled state, in which said elevator cabin is permitted to enter said shaft changeover unit, and a disabled state, in which said elevator cabin is blocked from entering said shaft changeover unit. Here, a first travel route from a first start position in the shaft system to a first destination position in the shaft system utilizing a first shaft changeover unit of the elevator installation is determined for a first elevator cabin of the elevator installation. The first elevator cabin is moved proceeding from the first start position, wherein the control system controls at least one travel parameter of the first elevator cabin such that the first elevator cabin, proceeding from the first start position, reaches the first shaft changeover unit when the first shaft changeover unit is in the enabled state for the first elevator cabin.

The first elevator cabin can thus advantageously directly enter the first shaft changeover unit. A stop of the first elevator cabin before the first shaft changeover unit is thus advantageously eliminated. Elevator users are thus advantageously not irritated by possible additional stops before the shaft changeover units which would be attributable to the shaft changeover unit firstly having to change over from the disabled state to the enabled state. Through the avoidance of such stops, in the case of which an elevator cabin has to wait until it can enter a shaft changeover unit, the transport capacity of the elevator installation as a whole is furthermore advantageously increased.

Here, a disabled state of a shaft changeover unit for an elevator cabin is in particular a state of said shaft changeover unit in which said elevator cabin is prohibited from entering said shaft changeover unit, in particular on the basis of a specification by the control system. Such prohibition exists in particular if it is technically not possible for said elevator cabin to enter the shaft changeover unit, in particular if the shaft changeover unit is in a state in which it has no connection to the travel route of the elevator cabin. Such prohibition however in particular also exists if the shaft changeover unit is already reserved for utilization for a further elevator cabin, that is to say said further elevator cabin is intended to utilize the shaft changeover unit first. This means that a disabled state of the shaft changeover unit, that is to say prohibition against utilization of the shaft changeover unit, may exist for an elevator cabin in particular also if it is technically possible for said elevator cabin to enter the shaft changeover unit but the shaft changeover unit is already reserved for a further elevator cabin that is intended to utilize the shaft changeover unit first.

Here, an enabled state of a shaft changeover unit for an elevator cabin is in particular a state of said shaft changeover unit in which said elevator cabin is permitted to enter said shaft changeover unit, in particular on the basis of a specification by the control system. Such permission exists in particular if it is technically possible for said elevator cabin to enter the shaft changeover unit, that is to say in particular if the shaft changeover unit is in a state in which it has a connection to the travel route of the elevator cabin. Such permission however in particular also exists if it is technically possible for said elevator cabin to enter the shaft changeover unit and the shaft changeover unit is already reserved for utilization for said elevator cabin. This means that, according to one advantageous refinement, the shaft changeover unit has for an elevator cabin only if firstly it is technically possible for said elevator cabin to enter the shaft changeover unit but also secondly the utilization of the shaft changeover unit by said elevator cabin is already intended, in particular by means of a reservation of the shaft changeover unit, for said elevator cabin.

In particular, provision is also made whereby a shaft changeover unit adopts the disabled state for a first elevator cabin and said shaft changeover unit simultaneously adopts the enabled state for a second elevator cabin. This may be the case in particular if the first elevator cabin has a different travel route than the second elevator cabin, for example the first elevator cabin is moved horizontally and the second elevator cabin is moved vertically. Furthermore, this may be the case if the first elevator cabin and the second elevator cabin have the same travel route, that is to say in particular said two elevator cabins are moved vertically, but the first elevator cabin is intended to utilize the shaft changeover unit first and the second elevator cabin is intended to utilize the shaft changeover unit only thereafter.

In particular, provision is made whereby the elevator cabins of the elevator installation are moved individually, that is to say substantially independently of one another, preferably by means of a linear motor drive. Here, the elevator cabins are preferably moved along rails in the elevator shafts, wherein the shaft changeover units are preferably rail segments which are designed to be rotatable, in particular so-called exchangers, which, by rotation, permit a travel route changeover, in particular a changeover from a vertical direction of travel to a horizontal direction of travel and vice versa. In particular, provision is furthermore made whereby the shaft system has a multiplicity of first rail tracks, which have a first orientation, and a multiplicity of second rail tracks, which have a second orientation, is moved with a second orientation in the shaft system, wherein the at least one shaft changeover unit has in each case one rotary rail track which is adjustable in terms of orientation between at least a first position and a second position, wherein the rotary rail track, in the first position, connects two first rail tracks to one another and, in the second position, connects two second rail tracks to one another. It may however also be possible for the shaft changeover unit to comprise rail tracks for the vertical direction and the horizontal direction. This means that the shaft changeover unit in this case advantageously does not need to rotate if it is intended for an elevator cabin to merely pass over the shaft changeover unit, that is to say no shaft changeover of said elevator cabin is intended.

In particular, the first elevator cabin is moved on the basis of a call placed by an elevator user. The call is preferably placed as a destination call. The control system correspondingly advantageously comprises a destination call controller.

A further particularly advantageous embodiment of the invention provides that both the movement of the first elevator cabin and the state of the first shaft changeover unit are controlled, in particular by the control system of the elevator installation, such that the first elevator cabin reaches the first shaft changeover unit when the first shaft changeover unit is in the first enabled state with regard to the first elevator cabin.

According to a further advantageous embodiment of the invention, the control system controls the at least one travel parameter of the first elevator cabin furthermore such that the first elevator cabin, proceeding from the first start position, reaches the first shaft changeover unit without any intermediate stops. This means that, in this embodiment of the proposed method, it is advantageously the case that each elevator cabin is moved from a start position to a destination position without intermediate stops, wherein the start position is preferably that position of the elevator cabin at which the elevator cabin performs the most recent planned floor stop in order to allow elevator users to embark into or disembark from the elevator car. Accordingly, provision is self-evidently made in particular whereby an elevator cabin is moved from a start floor to a destination floor, but in so doing stops at further intermediate floors, because these intermediate floors are in turn start and/or destination floors for further elevator users. Here, the start floor is however advantageously not the start position. The start position disadvantageously corresponds to the most recent intermediate floor at which the elevator cabin performs a planned stop in order to satisfy an embarking and/or disembarking demand of at least one elevator user. Intermediate stops of an elevator cabin in addition to the stops of the elevator cabin at the intermediate floors, owing to a disabled state of a shaft changeover unit for said elevator cabin, are advantageously eliminated. In other words, this however also means that the first elevator cabin advantageously reaches the first shaft changeover unit when the first shaft changeover unit is in the enabled state for the first elevator cabin, without the elevator cabin performing unplanned intermediate stops for this purpose, that is to say in particular without intermediate stops triggered by an embarking or disembarking demand of an elevator user. The first elevator cabin thus advantageously does not perform an intermediate step immediately before the first shaft changeover unit, but rather performs no intermediate stop whatsoever between the most recent planned floor stop and the shaft changeover unit. In this way, the transport capacity of the elevator installation is advantageously further improved.

A further advantageous embodiment of the invention provides for the control system to control the at least one travel parameter of the first elevator cabin furthermore taking into consideration the present state of the first shaft changeover unit. Here, the control system advantageously intervenes in the movement of the first elevator cabin with closed-loop control action if the present state of the first shaft changeover unit changes. In particular, here, the at least one travel parameter of the elevator cabin is correspondingly manipulated by the control system.

Accordingly, in particular, a situation may arise in which the first shaft changeover unit is in the enabled state for the first elevator cabin. This would for example mean that the first elevator cabin could be moved at high speed to the shaft changeover unit. Now, however, the situation may arise in which the first elevator cabin is still at a relatively great distance from the first shaft changeover unit and a further call by an elevator user causes the movement of a second elevator cabin, which is likewise intended to utilize the first shaft changeover unit. If said second elevator cabin is situated relatively close to the first shaft changeover unit, in particular in relation to the first elevator cabin, provision is made in particular whereby said second elevator cabin utilizes the shaft changeover unit first. For this purpose, the first shaft changeover unit must adopt the enabled position with regard to the second elevator cabin. This may in particular have the effect that the present state of the first shaft changeover unit changes from the enabled state to the disabled state for the first elevator cabin. In particular in a manner dependent on when the first shaft changeover unit can adopt the enabled state for the first elevator cabin again, the control system in this case, in particular as a result of this change in the state of the first shaft changeover unit, manipulates the at least one travel parameter of the first elevator cabin such that the travel of the first elevator cabin is slowed, such that, despite this change in the present state of the first shaft changeover unit, the elevator cabin reaches the first shaft changeover unit when the latter is in the enabled state for the first elevator cabin, and the first elevator cabin can thus directly enter the shaft changeover unit.

A further particularly advantageous embodiment of the invention provides that a state sequence is determined for the first shaft changeover unit, preferably by the control system of the elevator installation, wherein the most recent state of the state sequence is the enabled state assigned to the first elevator cabin. Here, the control system advantageously controls the at least one travel parameter of the first elevator cabin furthermore taking into consideration the state sequence. If multiple elevator cabins of the elevator installation are moved simultaneously, such as occurs in particular in the case of high volumes of passengers, there is in particular a more frequent occurrence of situations in which journeys of multiple elevator cabins of the elevator installation from start to destination positions are already determined, wherein it is intended for several of the elevator cabins to utilize the same shaft changeover unit, in particular the first shaft changeover unit. Here, there is a resulting sequence of when which elevator cabin utilizes the first shaft changeover unit, which results in turn in a state sequence for the first shaft changeover unit. This knowledge of the state sequence is advantageously utilized for the movement of the first elevator cabin. In particular, the travel of the first elevator cabin to the first shaft changeover unit is correspondingly slowed if it is already known that the shaft changeover unit has not yet fully adopted the enabled state for the first elevator cabin. A smoother traveling motion of the first elevator cabin is advantageously achieved in this way. In particular, in this way, a relatively frequent acceleration and deceleration of the first elevator cabin is avoided, which advantageously contributes to a further increase in travel comfort and furthermore has an energy-saving effect.

Furthermore, provision is made in particular whereby the state sequence is a dynamic state sequence, that is to say, owing to further travel routes set in the intervening time, further intermediate states may be adopted by the first shaft changeover unit, which are correspondingly taken into consideration in the movement of the first elevator cabin.

It is advantageously the case that one of the following travel parameters is controlled as the at least one travel parameter of the first elevator cabin: speed of the first elevator cabin; acceleration of the first elevator cabin; jerk of the first elevator cabin; dwell time of the first elevator cabin at the start position; deceleration of the first elevator cabin; door opening times of the first elevator cabin. In particular, provision is thus made whereby the speed of the first elevator cabin is reduced and/or the first elevator cabin is accelerated more slowly and/or the first elevator cabin is held at the start position for longer if, in the case of the corresponding standard travel parameters being utilized, the first elevator cabin would reach the first shaft changeover unit when the first shaft changeover unit is still in the disabled state with regard to the first elevator cabin. Here, the question of which travel parameters are influenced in which way is advantageously dependent on further criteria. Accordingly, as one criterion, provision is made in particular whereby the travel parameter is influenced such that the first elevator cabin, proceeding from the first start position, reaches the first shaft changeover unit when the first shaft changeover unit is in the enabled state for the first elevator cabin, wherein it is sought to optimize the energy requirement for the movement of the first elevator cabin. Furthermore, it is in particular also the case that the travel routes of further elevator cabins are taken into consideration as a further criterion. For example, if a further elevator cabin must stop at or pass the start position of the first elevator cabin, then the first elevator cabin will dwell at the start position for at most such a length of time that the travel of the further elevator cabin is not impeded. By contrast, a relatively long dwell time of the first elevator cabin in the case of a relatively high speed is provided in particular in the case of high volumes of passengers, in particular if the start position of the first elevator cabin coincides with a transfer floor. Here, the relatively long dwell time can advantageously be utilized in order to improve the filling of the elevator cabin, that is to say accommodate more elevator users in the first elevator cabin.

A further advantageous embodiment of the invention provides that a travel curve is predefined for the control of the at least one travel parameter of the first elevator cabin. Here, the travel curve is advantageously in each case calculated on a situational basis, in particular by the control system of the elevator installation. A further advantageous configuration variant provides that, from a set of predefined travel curves, one travel curve is determined from the set of travel curves on a situational basis. Here, the set of travel curves is advantageously stored in a memory unit. By means of the situational assignment of a travel curve for the first elevator cabin to a particular situation, which is defined in particular by the distance of the first elevator cabin to the first shaft changeover unit and/or the state sequence of the first shaft changeover unit, processing capacity is advantageously saved in relation to a situational calculation. Furthermore, with the specification of a set of travel curves for the control system, it is advantageously possible to determine in an improved manner when which elevator cabin will be where, under what conditions. In this way, it is advantageously possible to further improve the availability of the elevator cabins of the elevator installation and thus further increase the transport capacity of the elevator installation.

In particular, the control system of the elevator installation determines in each case one travel curve of the respective elevator cabin, in particular a speed travel curve, from the state parameters of the elevator installation. Such a travel curve is in particular a function of the position of the respective elevator cabin in the elevator shaft versus the time, or a function of the speed of the respective cabin in the elevator shaft versus the time, or versus the position of the elevator cabin. By means of such a travel curve, it is in particular possible for the position of the respective elevator cabin to be extrapolated. Taking into consideration this travel curve, the control system of the elevator installation determines in particular a travel curve for the first elevator cabin, in accordance with which the first elevator cabin is moved along the set travel route. Accordingly, the control system of the elevator installation advantageously determines the travel parameters of the first elevator cabin on the basis of the state parameters, and, from said travel parameters in turn, determines in particular the start point in time and the travel curve of the first elevator cabin.

As a further embodiment of the proposed invention, provision is made whereby a second travel route from a second start position in the shaft system to a second destination position in the shaft system utilizing the first shaft changeover unit is determined for a second elevator cabin of the elevator installation, wherein the state of the first shaft changeover unit is determined taking into consideration the first travel route and taking into consideration the second travel route. Here, it is advantageously in particular set whether the first shaft changeover unit is provided firstly for use by the first elevator cabin or firstly for use by the second elevator cabin. This setting is advantageously performed here by means of the control system of the elevator installation. Through the determination of the states of the first shaft changeover unit, the predictability of when the first elevator cabin must reach the first shaft changeover unit in order that the first shaft changeover unit is in the enabled state with regard to the first elevator cabin, and the first elevator cabin can thus advantageously directly enter the shaft changeover unit, is advantageously improved.

In one advantageous refinement, provision is furthermore made whereby the first shaft changeover unit successively adopts the enabled state for the first elevator cabin and the enabled state for the second elevator cabin. Here, provision may be made both whereby the first shaft changeover unit firstly adopts the enabled state for the first elevator cabin and then adopts the enabled state for the second elevator cabin and whereby the first shaft changeover unit firstly adopts the enabled state for the second elevator cabin and then adopts the enabled state for the first elevator cabin. It is crucial here merely that a deterministic determination is performed as regards when the first shaft changeover unit adopts the enabled state for the first elevator cabin and for the second elevator cabin. The sequence is advantageously optimized in particular on the basis of the criterion of the highest possible transport capacity of the elevator installation. In particular, provision is made whereby the states of the first shaft changeover unit are determined at least from the possible travel route alternatives from which the travel route for the first elevator cabin and the second elevator cabin is advantageously determined. Here, the states of the first shaft changeover unit advantageously ultimately define the travel parameters of the first elevator cabin and of the second elevator cabin. In this respect, the states of the shaft changeover units are advantageously bidirectionally linked with the travel routes of the elevator cabins that utilize said shaft changeover units.

It is preferably the case that a prioritization is performed with regard to the first travel route for the first elevator cabin and the second travel route for the second elevator cabin, in particular by the control system of the elevator installation. Here, by means of the prioritization, it is advantageously defined whether the first shaft changeover unit firstly adopts the enabled state for the first elevator cabin or firstly adopts the enabled state for the second elevator cabin. Here, for the prioritization, it is possible in particular for the travel routes to be assigned classification numbers which result from the evaluation of different criteria, such as in particular the number of elevator users to be transported in the elevator cabin and/or the predicted time until the shaft changeover unit is reached and/or the probability of stops at intermediate floors before the shaft changeover unit is reached and/or the checking of a VIP status assigned to an elevator cabin. Here, a large number of elevator users to be transported advantageously leads to an increase of the classification number. A short time—in particular in relation to the further elevator cabin—until the shaft changeover unit is reached advantageously likewise leads to an increase of the classification number. A high likelihood of stops at intermediate floors before the shaft changeover unit is reached advantageously leads to a reduction of the classification number. A VIP status assigned to an elevator cabin advantageously likewise leads to an increase of the classification number. The travel route which has received the higher classification number is preferably prioritized.

As a further refinement of the invention, provision is made whereby the state of the first shaft changeover unit is determined primarily by the second travel route and secondarily by the first travel route. It is advantageously thus the case that the first shaft changeover unit firstly adopts the enabled state for the second elevator cabin and only thereafter adopts the enabled state for the first elevator cabin. Here, it is advantageously taken into consideration that the state of the first shaft changeover unit is influenced not only by the first elevator cabin. Thus, according to a further aspect of the invention, provision is advantageously made whereby, in situations in which a travel route for a first elevator cabin is determined which provides the utilization of the first shaft changeover unit and the first elevator cabin can be moved in accordance with the determined travel route without the need for utilization of the first shaft changeover unit for a further elevator cabin, the first shaft changeover unit directly adopts the enabled state for said first elevator cabin. Here, control of the travel parameter of the first elevator cabin taking into consideration the state of the further shaft changeover unit can advantageously be omitted. Here, exceptions are advantageously provided. In particular, one such exception is provided if the first shaft changeover unit is in the disabled state for the first elevator cabin and the change into the enabled state takes longer than the movement of the first elevator cabin to the first shaft changeover unit. A further exception is provided in particular if, already during the movement of the first elevator cabin along the determined travel route, a further travel route is determined for a further elevator cabin and the control system identifies that said further travel route is to be prioritized, such that the state of the first shaft changeover unit must change once again.

The proposed method, in all refinements and refinement combinations, provides in particular that the elevator system comprises a multiplicity of elevator cabins, for each of which the proposed method steps must be performed. In particular, provision is thus made whereby the above-stated second elevator cabin is a further first elevator cabin. It is thus advantageously ultimately the case that all elevator cabins are first elevator cabins which utilize a multiplicity of first shaft changeover units, wherein the described method steps are advantageously carried out individually or in combination.

According to a further advantageous refinement of the invention, provision is made whereby a point in time is calculated when the first shaft changeover unit adopts the enabled state for the first elevator cabin. The control system advantageously controls the at least one travel parameter furthermore taking into consideration the calculated point in time. Here, the calculated point in time advantageously arises from the time required for a change from a disabled state into an enabled state or the time required for a change from an enabled state into a disabled state. Furthermore, the calculated point in time advantageously arises from a determined state sequence. Furthermore, the calculated point in time advantageously arises from the calculated times when prioritized elevator cabins that may utilize the first shaft changeover unit before the first elevator cabin have completed the utilization. In particular, provision is made whereby the calculated point in time is a dynamic point in time which is advantageously adapted on the basis of further subsequently prioritized elevator cabins.

The elevator installation proposed for achieving the object stated in the introduction is advantageously designed for carrying out the proposed method, in particular also for carrying out the method steps proposed in the further refinements. In particular, here, the elevator installation comprises a shaft system comprising at least two elevator shafts, comprises at least one elevator cabin which is movable in the shaft system, in particular a multiplicity of elevator cabins which are movable in the shaft system, comprises a control system, and comprises at least one shaft changeover unit. By means of the shaft changeover units, elevator cabins of the elevator installation can change over from a first elevator shaft of the shaft system into a second elevator shaft of the shaft system. Here, with regard to an elevator cabin of the elevator installation, a shaft changeover unit of the elevator installation can in each case adopt an enabled state and a disabled state, wherein, in the enabled state, said elevator cabin is permitted to enter said shaft changeover unit, and wherein, in the disabled state, said elevator cabin is blocked from entering said shaft changeover unit.

In particular, provision is made whereby the elevator shafts of the elevator installation are formed by rail tracks, wherein the at least one shaft changeover unit is a rotatable rail portion of a rail track. Here, it is advantageously the case that the shaft changeover unit, in a first position, permits travel on a first rail track with a first orientation. It is advantageously the case that the shaft changeover unit, in a second position, permits travel on a second rail track with a second orientation. In particular, the shaft changeover unit is in this case designed as a so-called exchanger.

Further advantageous details, features and refinement details of the invention will be discussed in more detail in conjunction with the exemplary embodiments illustrated in the figures, in which:

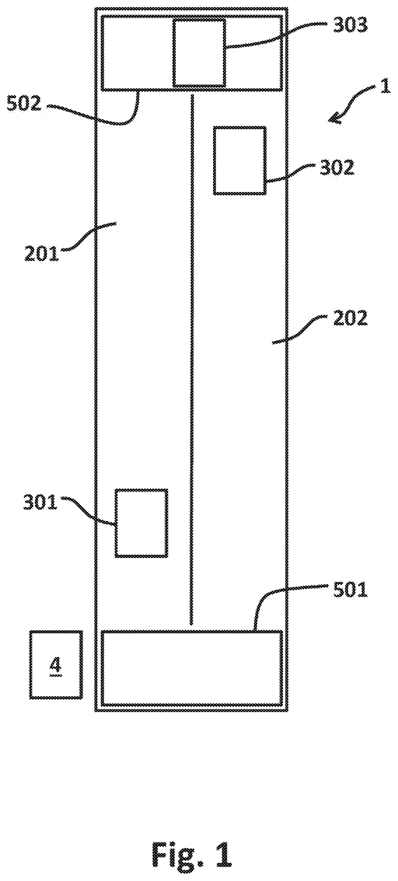

FIG. 1 shows, in a simplified schematic illustration, an exemplary embodiment of an elevator installation according to the invention;

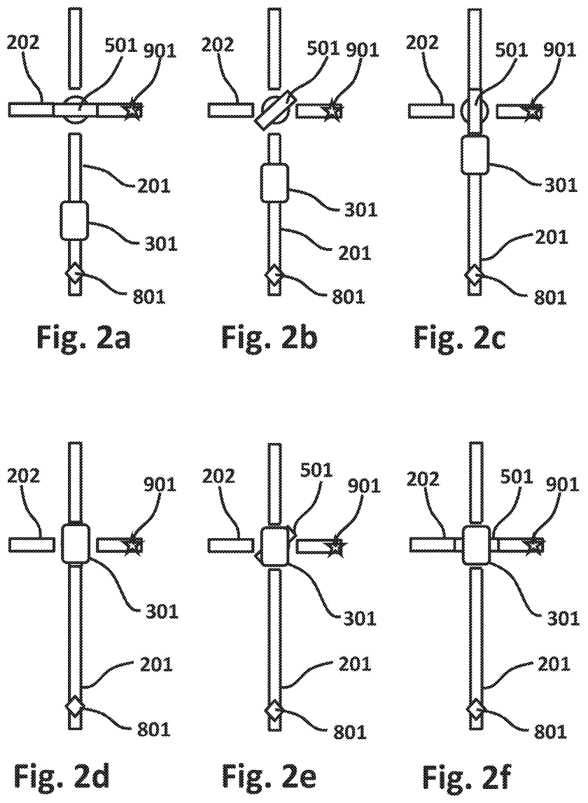

FIGS. 2a-2f each show, in a simplified schematic illustration, a detail of a further exemplary embodiment of an elevator installation according to the invention at different, successive points in time;

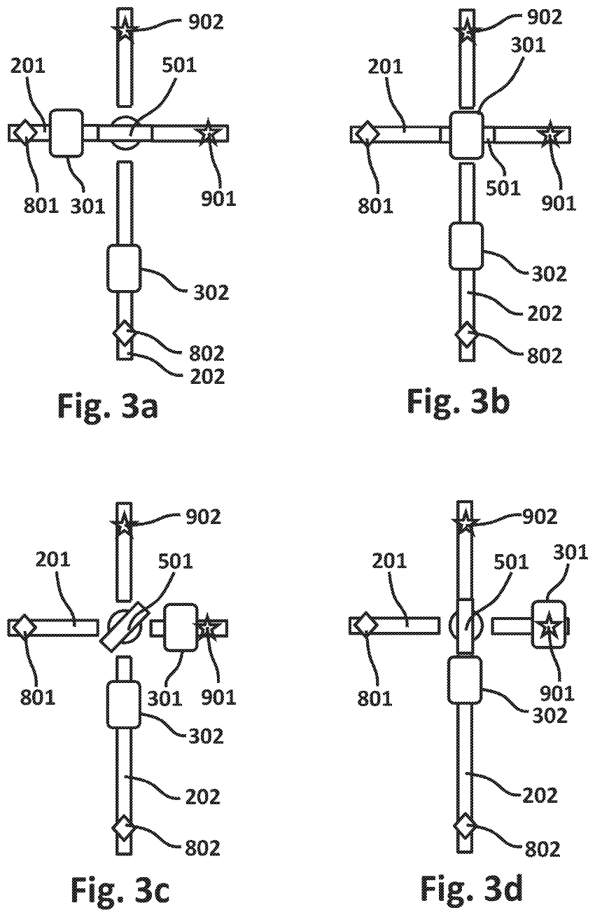

FIGS. 3a-3d each show, in a simplified schematic illustration, a detail of a further exemplary embodiment of an elevator installation according to the invention at different, successive points in time;

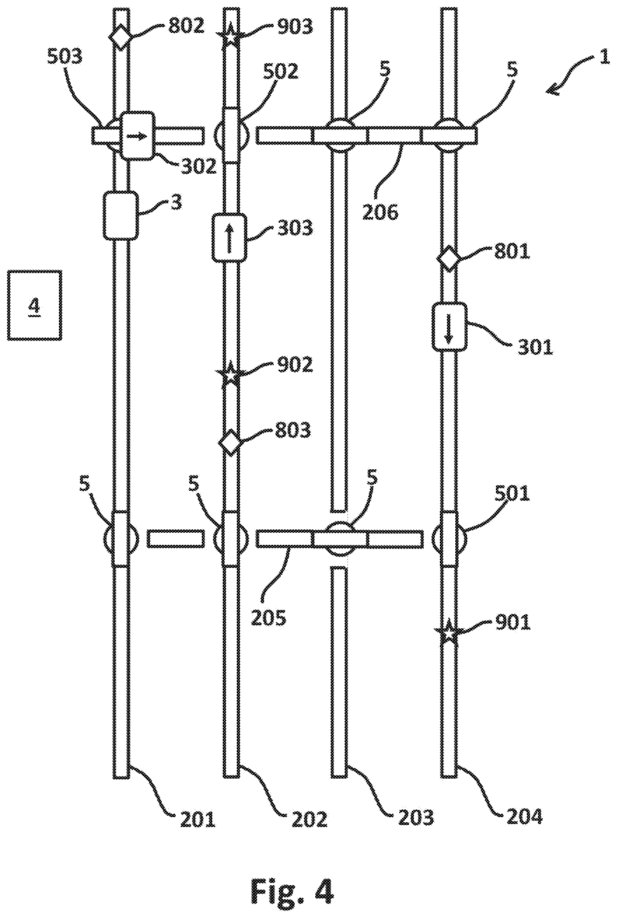

FIG. 4 shows, in a simplified schematic illustration, a further exemplary embodiment of an elevator installation according to the invention;

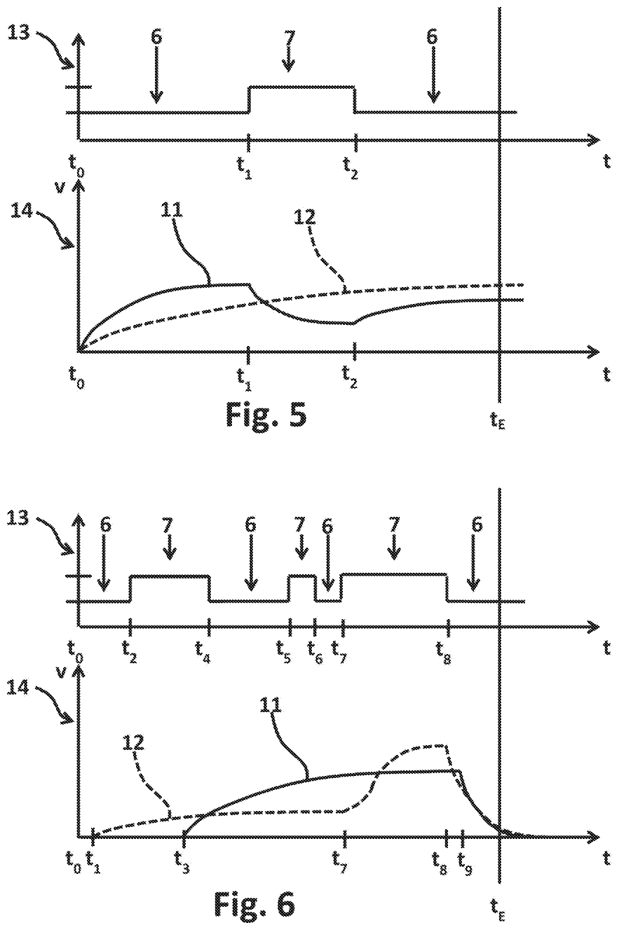

FIG. 5 shows, in a schematic illustration, an exemplary embodiment with regard to how, in the case of an elevator installation designed according to the invention, changes in state of a shaft changeover unit over time can lead to adaptations in the travel curve of an elevator cabin; and

FIG. 6 shows, in a schematic illustration, a further exemplary embodiment with regard to how, in the case of an elevator installation designed according to the invention, changes in state of a shaft changeover unit over time can lead to adaptations in the travel curve of an elevator cabin.

The elevator installation 1 shown in FIG. 1 comprises a shaft system 2 with a first elevator shaft 201 and a second elevator shaft 202. The elevator installation 1 furthermore comprises a multiplicity of elevator cabins 301, 302, 303. Said elevator cabins 301, 302, 303 can be moved individually in the elevator shafts 201, 202. For example, for moving the elevator cabins 301, 302, 303, the elevator installation 1 has a linear-motor drive with which the elevator cabins 301, 302, 303 can be moved. Alternatively, the elevator installation could for example also have a friction-wheel drive.

The elevator installation 1 furthermore comprises a first shaft changeover unit 501 and a second shaft changeover unit 502. By means of these shaft changeover units 501, 502, the elevator cabins 301, 302, 303 can change over from the first elevator shaft 201 into the second elevator shaft 202 and change over from the second elevator shaft 202 into the first elevator shaft 201. Here, the elevator installation 201 permits in particular so-called circulating operation of the elevator cabins 301, 302, 303.

The movement of the elevator cabins 301, 302, 303 is in this case controlled by means of a control system 4 of the elevator installation 1. Here, the control system 4 is illustrated merely schematically in FIG. 1, and may in particular also be a decentralized control system. In particular, provision is made whereby the control system 4 controls the drive system of the elevator installation. In particular, the control system also controls the shaft changeover units 501, 502. Here, with regard to one of the elevator cabins 301, 302, 303 of the elevator installation 1, the shaft changeover units 501, 502 can adopt either an enabled state or a disabled state, in particular in a manner controlled by the control system 4. In particular, provision may alternatively be made whereby the shaft changeover units 501, 502 each have a dedicated control unit, which control units control the state of the shaft changeover units 501, 502. In this case, the control units of the shaft changeover units 501, 502 advantageously have a communication connection to the control system 4. Here, in the enabled state, an entry of the elevator cabin into the respective shaft changeover unit is permitted for said elevator cabin. By contrast, in the disabled state, said elevator cabin is blocked from entering said shaft changeover unit.

For example, in the exemplary embodiment shown in FIG. 1, the elevator cabin 303 is changing over from the second elevator shaft 202 to the first elevator shaft 201 by means of the second shaft changeover unit 502. Since, in this exemplary embodiment, in each case only one elevator cabin can utilize a shaft changeover unit, the second shaft changeover unit 502 is thus disabled for the further elevator cabins 301 and 302. This means that the second shaft changeover unit 502 is in the disabled state for the elevator cabins 301 and 302.

Furthermore, provision is for example made whereby it is intended for the elevator cabin 302 to likewise change over from the second elevator shaft 202 into the first elevator shaft 201 by means of the second shaft changeover unit 502. This means that a travel route for said elevator cabin 302 has been determined which provides the utilization of the second shaft changeover unit 502. At least one travel parameter of the elevator cabin 302 is then controlled such that the elevator cabin 302 is moved such that said elevator cabin 302 reaches the second shaft changeover unit 502 no earlier than the time at which the second shaft changeover unit 502 has adopted the enabled state for the elevator cabin 302. For this purpose, the second shaft changeover unit 502 must firstly have moved the elevator cabin 303 from the second elevator shaft 202 into the first elevator shaft 201. When the utilization of the shaft changeover unit 502 by the elevator cabin 303 has been completed, then the second shaft changeover unit 502 changes from the disabled state into the enabled state for the elevator cabin 302. The change into the enabled state for the elevator cabin 302 advantageously coincides with the point in time at which the elevator cabin 302 reaches the shaft changeover unit 502, such that the elevator cabin 302 can enter the shaft changeover unit 502 directly, that is to say without having to stop before the shaft changeover unit 502.

Since, in the exemplary embodiment shown in FIG. 1, the first shaft changeover unit 501 is presently not being utilized by any of the elevator cabins 301, 302, 303, said shaft changeover unit 501 is initially in the enabled state for the elevator cabin 301 and for the elevator cabin 302. If, for example as a result of a call being placed by an elevator user, a travel route from a first start position in the second shaft 202 to a first destination position in the first shaft 201 is determined for the elevator cabin 302, then it is for example determined that the first shaft changeover unit 501 is utilized for this purpose, because the second shaft changeover unit 502 is presently in the disabled state for the elevator cabin 302. As a result of the determination of this travel route for the elevator cabin 302, which encompasses the utilization of the first shaft changeover unit 501, the first shaft changeover unit 501 advantageously adopts the disabled state for the elevator cabin 301, because the utilization of the shaft changeover unit 501 is now reserved for the elevator cabin 302. By contrast, the first shaft changeover unit 501 remains in the enabled state for the elevator cabin 302.

In particular, a refinement is also provided in which the shaft changeover units 501, 502 are basically initially in the disabled state for all elevator cabins 301, 302, 303. Only when a travel route which requires the utilization of one of the shaft changeover units 501, 502 is determined for one of the elevator cabins 301, 302, 303 does the shaft changeover unit intended for utilization change into the enabled state for said elevator cabin. Here, it is advantageously the case that a shaft changeover unit can always only be in an enabled state for one elevator cabin. If a further elevator cabin is to be handled first, this means that the shaft changeover unit must firstly change into the disabled state again for the elevator cabin for which the shaft changeover unit was already in the enabled state, and can only then change into the enabled state for the further elevator cabin.

FIG. 2a to FIG. 2f each illustrate a detail of an elevator installation. Here, provision is made whereby the elevator installation comprises a shaft system with a multiplicity of elevator shafts, in which a multiplicity of elevator cabins are moved. For example, the elevator installation may be an elevator installation as illustrated in FIG. 4. In particular, the elevator installation may in principle be an elevator installation as illustrated in FIG. 4, and may at the same time in particular be of such dimensions that the vertical elevator shafts of the elevator installation are longer than 100 meters, in particular longer than 400 meters.

Here, FIG. 2a to FIG. 2f each show the same detail, but at different, successive points in time. Here, a detail shows in each case an elevator shaft 201 of the elevator installation which extends in a vertical direction, and an elevator shaft 202 of the elevator installation which extends in a horizontal direction. In particular, provision is made whereby the elevator installation comprises a multiplicity of such horizontal elevator shafts and vertical elevator shafts. Furthermore, the detail shown in FIG. 2a to FIG. 2f illustrates in each case an elevator cabin 301, which is one of the multiplicity of elevator cabins of the elevator installation. Furthermore, the elevator installation comprises a control system, in particular a decentralized control system, which is not explicitly shown in the details illustrated. Furthermore, the elevator installation comprises a multiplicity of shaft changeover units, wherein the detail shown in FIG. 2a to FIG. 2f illustrates a shaft changeover unit 501 by means of which an elevator cabin, for example the elevator cabin 301, can change over from the shaft 201 into the shaft 202 or can change over from the shaft 202 into the shaft 201.

Here, the elevator cabins of the elevator installation are moved along rails, wherein the shaft changeover unit 501 is a rotatable rail segment, in particular a so-called exchanger. Here, exchangers are in particular designed to perform a rotation of up to 90 degrees, in particular in order to permit a changeover of an elevator cabin from a vertical elevator shaft into a horizontal elevator shaft and vice versa. This means that the exchanger can be rotated from an initial position through 90 degrees into an end position and in turn rotated from said end position through 90 degrees in the opposite direction of rotation into the initial position. Here, with regard to an elevator cabin of the elevator installation, the shaft changeover unit 501 can adopt an enabled state, in which said elevator cabin is permitted to enter said shaft changeover unit 501, and a disabled state, in which said elevator cabin is blocked from entering said shaft changeover unit 501.

Here, in the exemplary embodiment shown in FIG. 2a to FIG. 2f, a first travel route from a first start position 801 in the shaft 201 to a first destination position 901 in the elevator shaft 202 utilizing the shaft changeover unit 501 of the elevator installation has been determined for the elevator cabin 301. Here, provision is made in particular whereby the start position 801 is the embarking floor for an elevator user who has placed a destination call from the start position to the destination position 901. The destination position 901 is in this case the destination floor of the elevator user. Provision may however in particular also be made whereby the elevator cabin 301 has parked at the start position 801, that is to say was stopped at this position for the purposes of serving a future call. The elevator cabin 301 is in this case first moved from the start position 801 to the destination position 901 on the basis of a call demand that has been placed from the destination position 901. Here, the travel route determined for this purpose provides the utilization of the shaft changeover unit 501. The control system of the elevator installation then controls at least one travel parameter of the elevator cabin 301 such that the elevator cabin 301, proceeding from the start position 801, reaches the shaft changeover unit 501 when the shaft changeover unit 501 is in the enabled state for the elevator cabin 301.

Here, it is illustrated in FIG. 2a that the shaft changeover unit 501 is in the disabled state for the elevator cabin 301. In this disabled state, the shaft changeover unit 501 connects the horizontal shaft portions of the elevator shaft 202 to one another. In this disabled state, it is thus technically not possible for the elevator cabin 501 to enter the shaft changeover unit 501. In order that, at least from a technical aspect, the elevator cabin 301 can enter the shaft changeover unit 501, a rotation of the shaft changeover unit 501 is firstly necessary such that the shaft changeover unit 501 connects the shaft portions of the vertical elevator shaft 201 to one another. The rotation of the shaft changeover unit 501 and thus the change in state of the shaft changeover unit 501 are in this case advantageously controlled by the control system of the elevator installation.

Here, FIG. 2b illustrates the situation in which the control system has transmitted to the shaft changeover unit 501 the command to perform a rotation in order to connect the shaft portions of the elevator shaft 201 to one another. As the rotation of the shaft changeover unit 501 is performed, the shaft changeover unit 501 remains in the disabled state for the elevator cabin 301.

In parallel, the control system controls the speed of the elevator cabin 301, as a travel parameter of the elevator cabin 301, such that the elevator cabin 301, proceeding from the start position 801, reaches the shaft changeover unit 501 when the shaft changeover unit 501 has assumed the enabled state for the elevator cabin 301. Here, it is illustrated in FIG. 2c that the rotation of the shaft changeover unit 501 has been completed, and the shaft changeover unit 501 connects the vertical portions of the vertical elevator shaft 201 to one another. The shaft changeover unit 501 is then enabled for utilization by the elevator cabin 301 and assumes the enabled state for said elevator cabin 301. Here, the elevator cabin 301, proceeding from the start position 801, reaches the shaft changeover unit 501 without intermediate stops, that is to say without stopping again while traveling to the shaft changeover unit 501 after the start from the start position 801. As illustrated in FIG. 2d, the elevator cabin 301 can thus directly enter the shaft changeover unit 501. When the elevator cabin 301 has entered the shaft changeover unit 501, the shaft changeover unit 501 is activated by the control system of the elevator installation so as to, by means of a corresponding further rotation, produce the connection between the horizontal shaft portions of the elevator shaft 202 and thus allow the elevator cabin 301 to change over into the elevator shaft 202. Here, the further rotation of the shaft changeover unit 501 is illustrated in FIG. 2e. In particular, during this utilization of the shaft changeover unit 501 by the elevator cabin 301, the shaft changeover unit 501 cannot be utilized for further elevator cabins of the elevator installation. Here, the shaft changeover unit 501 is advantageously in the disabled state for said further elevator cabins.

It is illustrated in FIG. 2f that the shaft changeover unit 501 has produced the connection to the horizontal shaft 202. The elevator cabin 301 can now be moved onward to the destination position 901.

In the exemplary embodiment discussed on the basis of FIG. 2a to FIG. 2f, provision is made in particular whereby the elevator cabin 301 is controlled by the control system of the elevator installation taking into consideration the present state of the shaft changeover unit 501. This means that the control system takes into consideration the fact that, upon the start of the elevator cabin 301 from the start position 801, the shaft changeover unit 501 is initially in the disabled state for the elevator cabin 301, and the change of the shaft changeover unit 501 from the disabled state for the elevator cabin 301 into the enabled state takes place only as a result of corresponding activation of the shaft changeover unit 501 by the control system. As a result of the present state of the shaft changeover unit 501 being taken into consideration, a situation is advantageously prevented in which the elevator cabin 301 starts from the start position 801, in some cases with normal acceleration and normal speed, but then has to be braked or must even stop until the shaft changeover unit 501 adopts the enabled state for the elevator cabin 301.

FIG. 3a to FIG. 3d are in turn based on an elevator installation as discussed in conjunction with FIG. 2a to FIG. 2f. By contrast to the exemplary embodiment discussed in conjunction with FIG. 2a to FIG. 2f, this exemplary embodiment is based on two elevator cabins 301, 302 which are intended to utilize the same shaft changeover unit 501 in order to reach the respective destination position 901, 902.

Here, FIG. 3a illustrates the situation in which a first travel route from the first start position 801 to the first destination position 901 has been determined for the first elevator cabin 301. A second travel route from the second start position 802 to the second destination position 902 has been determined for the second elevator cabin 302. The first travel route for the first elevator cabin 301 and the second travel route for the second elevator cabin 302 in this case each provide the utilization of the shaft changeover unit 501.

The control system, not explicitly illustrated in FIG. 3a to FIG. 3d, of the elevator installation in this case controls both the movement of the elevator cabins 301, 302 and the shaft changeover unit 501. Here, the elevator cabins 301, 302 start from their respective start position 801, 802. Here, the shaft changeover unit 501 is initially in the enabled state for the elevator cabin 301, in which the elevator cabin 301 is permitted to enter said shaft changeover unit 501. For the elevator cabin 302, the shaft changeover unit 501 is in the disabled state, in which the elevator cabin 302 is blocked from entering the shaft changeover unit 501.

Since, upon the start of the elevator cabins 301, 302, the shaft changeover unit 501 is in the enabled state for the elevator cabin 301 and the elevator cabin 301 can reach the shaft changeover unit 501 more quickly owing to the shorter distance to the shaft changeover unit 501 the shaft changeover unit 501 than the elevator cabin 302, the control system defines that the first elevator cabin 301 may utilize the shaft changeover unit 501 first, and the second elevator cabin 302 may utilize the shaft changeover unit 501 only thereafter. This means that a state sequence is defined with regard to the utilization of the shaft changeover unit 501. Here, for the elevator cabin 301, a resulting state sequence is merely one state, specifically that the shaft changeover unit 501 is in the enabled state. Further states are of no further interest for the movement of the first elevator cabin 301 for the travel route from the first start position 801 to the first target position 901. With regard to the second elevator cabin 302, there is the resulting state sequence of disabled state, enabled state for the shaft changeover unit 501. This means that the shaft changeover unit 501 is initially in the disabled state for the second elevator cabin 302, and the subsequent and final state of the state sequence of the shaft changeover unit 501 with regard to the second elevator cabin 302 is the enabled state. Here, the control system of the elevator installation controls the movement of the first elevator cabin 301 for the state sequence that is relevant with regard to the elevator cabin 301, specifically the enabled state that is already present. Furthermore, the control system of the elevator installation controls the movement of the second elevator cabin 302 taking into consideration the state sequence that is relevant for said elevator cabin 302, specifically disabled state followed by enabled state.

Here, in particular the acceleration and the speed for the elevator cabins 301, 302 are predefined taking into consideration the state sequence of the shaft changeover unit 501. Since, for the first elevator cabin 301, the shaft changeover unit 501 is directly in the enabled state, the elevator cabin 301 is in this case advantageously moved with normal acceleration and normal speed and can enter the shaft changeover unit 501 directly, that is to say in particular without further intermediate stops. Since the control system furthermore has the information that the first elevator cabin 301 will be handled first by the shaft changeover unit 501 in order to reach the destination position 901, and it is thus in particular known to the control system that the shaft changeover unit 501 cannot directly change into the enabled state for the second elevator cabin 302, the second elevator cabin 302, proceeding from the second start position 802, is accelerated more slowly, and is moved at a slower speed, than the first elevator cabin 301.

Since, in the exemplary embodiment shown, the destination position 901 of the first elevator cabin 301 is situated in the same elevator shaft 201, the utilization of the shaft changeover unit 501 simply provides a passing-over of the shaft changeover unit 501. The rail portion of the shaft changeover unit 501 thus does not need to be rotated for the first elevator cabin 301 in order that the first elevator cabin 301 can move to the destination position 901. After the first elevator cabin 301 has passed over the shaft changeover unit 501 without intermediate stops, the rail portion of the shaft changeover unit 501 is rotated. In particular, provision is made whereby the shaft changeover unit is rotated by at most 180 degrees, preferably by no more than 135 degrees, proceeding from an initial position, in particular so as not to excessively twist cable connections that lead to the elevator cabin situated in the shaft changeover unit. During the rotation of the shaft changeover unit 501, as shown in FIG. 3c, the shaft changeover unit 501 remains in the disabled state for the second elevator cabin 302. This is because the second elevator cabin 302 still cannot enter the shaft changeover unit 501 as long as the rotation of the shaft changeover unit is taking place.

The second elevator cabin 302 advantageously reaches the shaft changeover unit 501 as the shaft changeover unit 501 adopts the enabled state with regard to the second elevator cabin 302, as illustrated in FIG. 3d. Here, the second elevator cabin 302 reaches the shaft changeover unit 501 without having to stop, even though the shaft changeover unit 501 was initially in the disabled state for said elevator cabin 302. The second elevator cabin 302 can thus directly enter the shaft changeover unit 501 and pass over said shaft changeover unit 501 in order to be moved onward to the destination position 902. Here, the second elevator cabin 302 is advantageously accelerated after reaching the shaft changeover unit 501, in order to be moved onward at normal speed and reach the destination position 902 more quickly. The travel route between the start position 801 and destination position 901 can thus be covered by the first elevator cabin 301 without intermediate stops. The travel route between the start position 802 and the destination position 902 can advantageously be covered by the second elevator cabin 302 without intermediate stops.

In particular, in the exemplary embodiment shown in FIG. 3a to FIG. 3d, it is however also possible for the situation to arise in which, for example when a travel route has already been determined for the elevator cabin 302 from the start position 802 to the destination position 902, a further call is placed by an elevator user. The effect of this further call is that the elevator cabin 302 is intended to stop again at an intermediate floor, in order to allow a further elevator user to embark, already before the shaft changeover unit 501 is reached. Owing to this additional stop and the associated waiting time, provision is in this case made whereby the elevator cabin 302 is moved to this intermediate floor at normal speed and also departs from the intermediate floor at normal speed and with normal acceleration if it is ensured here, in particular by the control system, that the elevator cabin 302 can reach the shaft changeover unit 501 without further deceleration and without having to perform another intermediate stop, and can directly enter and pass over said shaft changeover unit 501.

In particular, with regard to the elevator system illustrated in FIG. 3a to FIG. 3d, a further situation may arise in which the travel route from the start position 802 to the destination position 902 has firstly been determined for the second elevator cabin 302. Here, for as long as no travel route has been determined for the elevator cabin 301, the control system can in this case control the shaft changeover unit 501 such that the shaft changeover unit 501 adopts the enabled state for the elevator cabin 302. Since this change of state can in this case be performed more quickly, because it is not necessary to firstly wait for the shaft changeover unit 501 to be utilized by the elevator cabin 301, it would be possible in this case for the elevator cabin 302 to be started with normal acceleration and at normal speed.

If, however, shortly after the start of the second elevator cabin 302, a further call were to be placed, on the basis of which the travel route from the start position 801 to the destination position 901 is determined for the first elevator cabin 301, then the control system of the elevator installation would identify that, owing to the shorter distance to the shaft changeover unit 501, the elevator cabin 301 can reach the shaft changeover unit 501 more quickly than the second elevator cabin 302. In this respect, the overall availability of the elevator installation and thus the transport capacity of the elevator installation would increase if the first elevator cabin 301 utilizes the shaft changeover unit 501 first, and the second elevator cabin 302 utilizes the shaft changeover unit 501 only thereafter. In order that the second elevator cabin 302 however does not have to perform a stop, which is perceived as unpleasant by users situated in the second elevator cabin 302, before the shaft changeover unit 501, the control system advantageously manipulates the deceleration of the second elevator cabin 302 and the speed of the second elevator cabin 302 as travel parameters. This means that the second elevator cabin 302 is decelerated somewhat and moved onward at a slow speed, specifically such that the second elevator cabin 302 reaches the shaft changeover unit 501 when the shaft changeover unit 501 is in the enabled state for the second elevator cabin 302, and the second elevator cabin 302 can thus directly enter and pass over this shaft changeover unit 501.

In the exemplary embodiment discussed in conjunction with FIG. 3a to FIG. 3d, the shaft changeover unit 501 thus successively adopts the enabled state for the first elevator cabin 301 and for the second elevator cabin 302. Here, a prioritization is advantageously performed with regard to the first travel route from the first start position 801 to the first destination position 901 and the second travel route from the second start position 802 to the second destination position 902. Here, in this exemplary embodiment, it is defined by means of this prioritization that the shaft changeover unit 501 adopts the enabled state for the first elevator cabin 301 and adopts the enabled state for the second elevator cabin 302 only thereafter. Here, in this exemplary embodiment, the prioritization performed is based on the fact that the distance from the first elevator cabin 301 to the shaft changeover unit 501 is shorter than the distance from the present position of the second elevator cabin 302 to the shaft changeover unit 501, and it is the case that the first elevator cabin 301 can reach the shaft changeover unit 501 more quickly. Furthermore, in this case, it is in particular also taken into consideration in the prioritization that the shaft changeover unit 501 is already in the enabled state for the first elevator cabin 301.

FIG. 4 shows an elevator installation 1 with four vertical elevator shafts 201, 202, 203, 204 and with two horizontal elevator shafts 205, 206. The elevator installation 1 shown in FIG. 4 comprises a multiplicity of elevator cabins 3, 301, 302, 303. Here, arrows illustrated in the elevator cabins 301, 302, 303 symbolize a movement of these elevator cabins in the direction of the arrow. Furthermore, the elevator installation 1 comprises a control system 4. Furthermore, the elevator installation 1 comprises a multiplicity of shaft changeover units 5, 501, 502, 503. By means of these shaft changeover units 5, 501, 502, 503, an elevator cabin 3, 301, 302, 303 can change over from one elevator shaft of the elevator installation 1 into a further elevator shaft of the elevator installation. For example, the elevator cabin 3 can change over from the elevator shaft 201 into the elevator shaft 205 by means of the shaft changeover unit 5, or the elevator cabin 3 can change over from the elevator shaft 201 into the elevator shaft 204 utilizing multiple shaft changeover units 5.

Here, with regard to an elevator cabin of the elevator installation 1, a shaft changeover unit 5, 501, 502, 503 of the elevator installation 1 can adopt an enabled state and a disabled state. Here, in an enabled state of a shaft changeover unit for an elevator cabin, said elevator cabin is permitted to enter said shaft changeover unit. By contrast, in a disabled state, said elevator cabin is blocked from entering said shaft changeover unit. For example, the shaft changeover unit 502 is in the enabled state for the elevator cabin 303, but is in the disabled state for the elevator cabin 302.

In the exemplary embodiment illustrated in FIG. 4, it is furthermore provided that the vertical elevator shafts 201, 202, 203, 204 and the horizontal elevator shafts 205, 206 are formed by rail tracks. Here, the shaft changeover units 5, 501, 502, 503 are rotatable rail portions of said rail tracks. Here, in a first position of a shaft changeover unit of the elevator installation 1, an elevator cabin is permitted to travel on a first rail track with a first orientation, and, in a second position, travel is permitted on a second rail track with a second orientation. In particular, the shaft changeover unit is a rotary rail track, wherein the rotary rail track, in the first position, connects two first rail tracks to one another and, in the second position, connects two second rail tracks to one another.

In the exemplary embodiment shown in FIG. 4, provision may now be made whereby, for example, a first travel route from the start position 801 to the destination position 901 is determined for the elevator cabin 301. Here, the movement of the elevator cabin 301 is performed to take into consideration the state of the shaft changeover unit 501. Here, in the case shown in FIG. 4, the shaft changeover unit 501 adopts the enabled state for the elevator cabin 301. Taking into consideration the state of the shaft changeover unit 501, the elevator cabin 301 is moved, specifically such that the elevator cabin 301 reaches the shaft changeover unit 501 in the enabled state, such that the elevator cabin 301 can directly enter and pass over the shaft changeover unit 501 in order to be moved to the destination position 901.

Furthermore, in the exemplary embodiment illustrated in FIG. 4, provision is made whereby a further travel route from a start position 803 to a destination position 903 is determined for a further elevator cabin 303. Here, this travel route comprises the utilization of the shaft changeover unit 502. The shaft changeover unit 502 has in this case already been reserved for the elevator cabin 303 and has already adopted the enabled state for the elevator cabin 303, such that the elevator cabin 303, proceeding from the start position 803, reaches the shaft changeover unit 502 situated in the enabled state without performing intermediate stops, and can enter and pass over said shaft changeover unit 502 in order to then be moved onward to the destination position 903 without stopping.

Furthermore, in the exemplary embodiment illustrated in FIG. 4, provision is made whereby a further travel route from a start position 802 to a destination position 902 has been determined for a further elevator cabin 302. This travel route comprises the utilization of two shaft changeover units, specifically the shaft changeover unit 503 and the shaft changeover unit 502. In the state shown, the elevator cabin 302 has already entered the shaft changeover unit 503. The shaft changeover unit 503 has already been correspondingly rotated such that the elevator cabin 302 has already been changed over from the shaft 201 into the shaft 206. The destination position 902 of the elevator cabin 302 now provides a further shaft changeover from the shaft 206 into the shaft 202. For this purpose, it is necessary for the elevator cabin 302 to utilize the shaft changeover unit 502. Here, at the point in time shown in FIG. 4, the shaft changeover unit 502 is however in the enabled state for the elevator cabin 303. This means that the shaft changeover unit 502 is in the disabled state for the elevator cabin 302. In order that the elevator cabin 302 can nevertheless, proceeding from its present position, enter the shaft changeover unit 502 without performing intermediate stops, the control system 4 manipulates the travel parameters of the elevator cabin 302 such that said elevator cabin 302 reaches the shaft changeover unit 502 only when the shaft changeover unit has already adopted the enabled state for the elevator cabin 302. For this purpose, it is in particular taken into consideration that a state sequence has already been defined for the shaft changeover unit 502. Since it is imperatively necessary for said elevator cabin 303 to have first passed the shaft changeover unit 502 in order that the elevator cabin 302 can arrive at the destination position 803 in the first place, the travel route of the elevator cabin 303 is prioritized over the travel route of the elevator cabin 302. Therefore, the shaft changeover unit 502 is firstly reserved for the elevator cabin 303. This means that, in this case, the state of the shaft changeover unit 502 is determined primarily by the travel route of the elevator cabin 303 and secondarily by the travel route of the elevator cabin 302. Therefore, the shaft changeover unit 502 firstly adopts the enabled state for the elevator cabin 303 and only thereafter adopts the enabled state for the elevator cabin 302. In particular, here, provision may furthermore be made whereby not only the state sequence of the shaft changeover unit 502 is taken into consideration. Furthermore, it is in particular possible to calculate, by means of the control system 4, when the elevator cabin 303 will have passed the shaft changeover unit 502, and how long it will take until the shaft changeover unit 502 has attained the enabled state for the elevator cabin 302, such that a point in time at which the shaft changeover unit 502 adopts the enabled state for the elevator cabin 302 is calculated by the control system 4 on the basis of these data. Here, the control system 4 controls the travel parameters of the elevator cabin 302, in particular the speed of the elevator cabin 302, in particular also taking into consideration the calculated point in time at which the shaft changeover unit 502 will have adopted the enabled state for the elevator cabin 302.

Furthermore, it is in particular also possible, with regard to an elevator installation 1 as illustrated in FIG. 4 and described in conjunction with FIG. 4, for a travel curve to be predefined as a travel parameter for the elevator cabins. Examples for the specification of such travel curves are illustrated in FIG. 5 and FIG. 6. Here, in FIG. 5 and FIG. 6, the state 13 of a shaft changeover unit is plotted versus the time tin the upper of the illustrated diagrams in each case. Two different travel curves 11, 12 for the elevator cabin under consideration are plotted as a function of the speed v versus the time tin each case in the diagram arranged therebelow in FIG. 5 and FIG. 6.

Here, in the exemplary embodiment shown in FIG. 5, proceeding from a point in time t₀, the shaft changeover unit initially adopts the enabled state 6 for the elevator cabin under consideration. At a later point in time t₁, the shaft changeover unit changes into the disabled state 7 for the elevator cabin under consideration.

In this exemplary embodiment, provision is now made whereby, at the point in time to, the elevator cabin under consideration has been designated for serving a destination call and starts at this point in time. Here, the point in time t_{E}, which is illustrated by a continuous line, denotes the point in time at which the elevator cabin reaches the shaft changeover unit, wherein it is the intention for the enabled state for the elevator cabin to have been adopted when the shaft changeover unit is reached.

Here, the elevator cabin is moved, taking into consideration the state of the shaft changeover unit, in accordance with a predefined travel curve 11, 12. This means that a change in the state of the shaft changeover unit has an effect on the movement of the elevator cabin. Here, specifically, the travel curve for the elevator cabin is correspondingly adapted. Here, in a first embodiment, the elevator cabin is moved in accordance with the travel curve 12. This embodiment assumes that, at the point in time to, that is to say when the elevator cabin commences travel, the state sequence for the shaft changeover unit for this elevator cabin is already known. This means that the elevator cabin is initially not moved at maximum speed, but rather is accelerated slowly, because the control system knows that the shaft changeover unit will, for the elevator cabin, change once again into the disabled state for said elevator cabin at the point in time t₁, that is to say before the shaft changeover unit can be reached. As a result of the slowed acceleration, the elevator cabin then reaches the shaft changeover unit with a predefined constant speed in accordance with the travel curve 12, and can pass over the shaft changeover unit at constant speed, without a changeover of elevator shaft.

Here, the travel curve 12 may be calculated by the control system or may be selected from a stored set of travel curves. Here, the travel curve 12 is based on the fact that the state sequence of the shaft changeover unit, that is to say the change from the enabled state 6 into the disabled state 7 and the change from the disabled state 7 back into the enabled state 6, is known to the control system.

By contrast, in a second embodiment, provision is made whereby the change of the shaft changeover unit from the enabled state was not known in the control system at the point in time t₀. This embodiment forms the basis of the travel curve 11. Owing to the fact that, at the point in time to at which the elevator cabin commences travel, the shaft changeover unit is in the enabled state for said elevator cabin, but in this case the control system does not know that this enabled state will not be maintained, the elevator cabin starts with a higher speed in relation to the first embodiment with the travel curve 12. Here, the elevator cabin initially almost reaches normal speed, but must then, owing to the fact that the shaft changeover unit adopts the disabled state for the elevator cabin at the point in time t₁, be braked again such that the speed of the elevator cabin decreases, as can be seen from the travel curve 11. Only upon the ending of the disabled state at the point in time t₂ is the elevator cabin accelerated again slightly, such that the elevator cabin, nevertheless without having to perform an intermediate stop, reaches the shaft changeover unit when the latter is in the enabled state for the elevator cabin. It is thus also the case in this second embodiment that the elevator cabin can directly enter the shaft changeover unit, and pass over the latter, without stopping.

FIG. 6 shows a further exemplary embodiment for two different scenarios. Here, in a first embodiment, it is taken as a basis that the changes in state of the shaft changeover unit shown in the upper diagram are known to the control system. This forms the basis of the travel curve 11 for the elevator cabin. Here, it is in turn assumed that the elevator cabin has, at the point in time to, been designated for serving a placed call. On the basis of the change in state, known to the control system, of the shaft changeover unit that is to be utilized by the elevator cabin, the elevator cabin is however not started immediately at the point in time t₀, because the control system has determined that the elevator cabin, if it starts at the point in time t₀, will not reach the shaft changeover unit when it is in the enabled state for said elevator cabin. Instead, the elevator cabin is held for a certain period of time, in particular with the doors open, at the stopping point at which it is situated, that is to say at the start position. It is only at the point in time t₃ that the elevator cabin is accelerated up to a certain speed, which is then maintained. The elevator cabin is braked only shortly before the shaft changeover unit is reached, in order to be able to directly enter the shaft changeover unit. There, in this case, the elevator cabin must stop in the shaft changeover unit, because it is the intention for the elevator cabin to change over into another elevator shaft by means of the shaft changeover unit. For this purpose, the shaft changeover unit must change its state again when the elevator cabin has entered it.

Alternatively, the exemplary embodiment shown in FIG. 6 provides for movement of the elevator cabin in accordance with the travel curve 12. Here, provision is made whereby the elevator cabin is initially accelerated slowly and is then moved at a low constant speed, for example in order to clear the travel route for a further elevator cabin and not block a stopping point. In this case, the elevator cabin is then accelerated again at the point in time t₇ up until the point in time t₈. Then, as can also be seen from the travel curve 12, the elevator cabin is braked in order that, in turn, when the shaft changeover unit is reached, the shaft changeover unit is in the enabled state for the elevator cabin and entry into the shaft changeover unit is thus permitted.

The exemplary embodiments illustrated in the figures and discussed in conjunction therewith serve for the explanation of the invention, and do not restrict the latter.

### LIST OF REFERENCE DESIGNATIONS

1 Elevator installation

2 Shaft system

201 First elevator shaft

202 Second elevator shaft

3 Elevator cabin

301 First elevator cabin

302 Second elevator cabin

303 Third elevator cabin

304 Elevator cabin

4 Control system

5 Shaft changeover unit

501 First shaft changeover unit

502 Second shaft changeover unit

503 Third shaft changeover unit

6 Enabled state with regard to an elevator cabin

7 Disabled state with regard to an elevator cabin

801 First start position

802 Second start position

901 First destination position

902 Second destination position

10 State sequence

11 Travel curve

12 Travel curve

13 State of the shaft changeover unit over time

14 Speed of an elevator car over time

1.-14. (canceled)

15. A method for operating an elevator installation that includes a shaft system with a first elevator shaft and a second elevator shaft, an elevator cabin that is movable in the shaft system, a control system, and a shaft changeover unit by way of which the elevator cabin can move from the first elevator shaft to the second elevator shaft, wherein in an enabled state of the shaft changeover unit the elevator cabin can enter the shaft changeover unit and in a disabled state of the shaft changeover unit the elevator cabin is prevented from entering the shaft changeover unit, the method comprising:
determining for the elevator cabin a travel route from a start position in the shaft system to a destination position in the shaft system utilizing the shaft changeover unit; and
moving the elevator cabin from the start position, wherein the control system controls a travel parameter of the elevator cabin such that the elevator cabin reaches the shaft changeover unit when the shaft changeover unit is in the enabled state.

16. The method of claim 15 wherein the control system controls the travel parameter such that the elevator cabin, proceeding from the start position, reaches the shaft changeover unit without an intermediate stop.

17. The method of claim 15 wherein the control system controls the travel parameter so as to consider a present state of the shaft changeover unit.

18. The method of claim 15 comprising determining a state sequence for the shaft changeover unit, wherein a most-recent state of the state sequence is the enabled state assigned to the elevator cabin, wherein the control system controls the travel parameter so as to consider the state sequence.

19. The method of claim 15 wherein the travel parameter comprises at least one of:
speed of the elevator cabin;
acceleration of the elevator cabin;
jerk of the elevator cabin;
dwell time of the elevator cabin at the start position;
deceleration of the elevator cabin; or
door opening times of the elevator cabin.

20. The method of claim 15 comprising predefining a travel curve for the travel parameter, wherein either
the travel curve is calculated on a situational basis; or
the travel curve is determined from a set of predefined travel curves on a situational basis.

21. The method of claim 15 wherein the elevator cabin is a first elevator cabin, wherein the travel route is a first travel route, wherein the start position is a first start position, wherein the destination position is a first destination position, the method comprising determining for a second elevator cabin a second travel route from a second start position in the shaft system to a second destination position in the shaft system utilizing the shaft changeover unit, wherein a state of the shaft changeover unit is determined taking into consideration the first and second travel routes.

22. The method of claim 21 wherein the shaft changeover unit successively adopts the enabled state for the first elevator cabin and the enabled state for the second elevator cabin.

23. The method of claim 22 comprising prioritizing with respect to the first and second travel routes, wherein prioritizing comprises defining whether the shaft changeover unit adopts the enabled state for the first elevator cabin first or adopts the enabled state for the second elevator cabin first.

24. The method of claim 21 wherein a state of the shaft changeover unit is determined primarily by the second travel route and secondarily by the first travel route such that the shaft changeover unit adopts the enabled state for the second elevator cabin and thereafter adopts the enabled state for the first elevator cabin.

25. The method of claim 21 wherein the second elevator cabin is configured like the first elevator cabin.

26. The method of claim 21 comprising calculating a point in time when the shaft changeover unit adopts the enabled state for the first elevator cabin, wherein the control system controls the travel parameter of the first elevator cabin taking into consideration the calculated point in time.

27. The method of claim 15 comprising calculating a point in time when the shaft changeover unit adopts the enabled state for the elevator cabin, wherein the control system controls the travel parameter of the elevator cabin taking into consideration the calculated point in time.

28. An elevator installation comprising:
a shaft system with a first elevator shaft and a second elevator shaft;
an elevator cabin that is movable in the shaft system;
a control system; and
a shaft changeover unit by way of which the elevator cabin can move from the first elevator shaft into the second elevator shaft, wherein the shaft changeover unit is configured to adopt an enabled state whereby the elevator cabin is permitted to enter the shaft changeover unit and is configured to adopt a disabled state whereby the elevator cabin is prevented from entering the shaft changeover unit.

29. The elevator installation of claim 28 wherein the first and second elevator shafts comprise rail tracks, wherein the shaft changeover unit is a rotatable rail portion of the rail tracks, wherein in a first position the shaft changeover unit permits travel on a first rail track with a first orientation, wherein in a second position the shaft changeover unit permits travel on a second rail track with a second orientation.
